(19) United States
(12) Patent Application Publication
(10) Pub. No.: US 2013/0188181 A1
(43) Pub. Date: Jul. 25, 2013

(54) Systems and Methods for Spatial Heterodyne Raman Spectroscopy

(71) Applicants: Stanley Michael Angel, Columbia, SC (US); Jerry Chance Carter, Livermore, CA (US); Nate Gomer, Lexington, SC (US)

(72) Inventors: Stanley Michael Angel, Columbia, SC (US); Jerry Chance Carter, Livermore, CA (US); Nate Gomer, Lexington, SC (US)

(21) Appl. No.: 13/654,924

(22) Filed: Oct. 18, 2012

Related U.S. Application Data
(60) Provisional application No. 61/548,373, filed on Oct. 18, 2011.

(51) Int. Cl. G01J 3/44; G01J 3/45

(52) U.S. Cl. CPC G01J 3/44; G01J 3/45
USPC 356/301

(57) ABSTRACT

The present subject matter is directed to a device for spectroscopy. The device includes an excitation source configured to illuminate a sample with wavelengths. The device also includes a spatial heterodyne interferometer configured to receive Raman wavelengths from the sample.

### GOVERNMENT SUPPORT CLAUSE

This invention was made with government support under CHE-0526821 awarded by National Science Foundation. The government has certain rights in the invention.

### BACKGROUND

There is an interest in developing systems that can enable new research capabilities in the field of astrobiology such as the ability to measure biomarkers, both organic and inorganic. Raman spectroscopy is ideally suited to measure biomarkers. The following criteria are important considerations for planetary missions: high spectral resolution (5 cm⁻¹ or better), large spectral band pass (250-3800 cm⁻¹), high sensitivity, and a small lightweight form factor. Additionally, suitable systems must be capable of operating over standoff distances (i.e., tens of meters) in planetary ambient light conditions with sufficient sensitivity to measure low biomarker concentrations; criteria that can be addressed by using ultraviolet (UV) pulsed laser excitation, providing both increased Raman scattering efficiency (relative to visible or near-infrared excitation wavelengths) and additional signal enhancements via resonance effects for UV absorbing biomarkers. Small near-infrared (IR) Raman dispersive systems potentially meet the spectral resolution and band pass criteria but lack the sensitivity enhancements provided by UV excitation. While near-infrared (NIR) wavelengths (compared to UV) penetrate more deeply into materials, the expected low concentration of biomarkers suggests that the use of NIR laser excitation would lead to higher background interferences resulting in lower sensitivity because more of the underlying materials are sampled. The use of visible wavelength Raman dispersive systems would likely produce very intense broadband fluorescence background signals, thereby masking the Raman signal. Dispersive, diffraction grating based UV Raman systems are inherently very large in order to provide sufficient spectral resolution and have very low light throughput because of the requirement for small slit widths. Existing nondispersive UV Raman systems (e.g., tunable filter based) have very low spectral resolution or are not compatible with pulsed laser excitation and gated detection (e.g., any design that involves scanning to produce a spectrum such as Hadamard, coded aperture, FT Raman, and most tunable filter designs must involve “step scanning”), which have been shown to be essential for ambient light measurements.

As such, it would be desirable to provide suitable systems and methods for Raman spectroscopy to measure biomarkers and other samples of interest such as minerals, water, CO₂ ice, or the like.

### SUMMARY

Aspects and advantages of the invention will be set forth in part in the following description, or may be obvious from the description, or may be learned through practice of the invention.

In one aspect, the present subject matter is directed to a device for spectroscopy. The device includes an excitation source configured to illuminate a sample with wavelengths. The device also includes a spatial heterodyne interferometer configured to receive Raman wavelengths from the sample.

In yet another aspect of the present disclosure, a method of spectroscopy is described. The method includes illuminating a sample with wavelengths from an excitation source. The method utilizes a spatial heterodyne interferometer to receive Raman wavelengths from the sample.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a schematic of SHS Raman spectrometer system layout in accordance with certain aspects of the present disclosure ((L) Lens, (G) grating, (BS) beam splitter, (F) laser rejection filter, (I) iris/aperture, (S) sample holder, and (ICCD) intensified charge-coupled device or (CCD) charge coupled device, the laser is not shown here but the beam is focused onto the sample from the top);

FIG. 2 depicts a CCl₄ spectrum Fourier transform of the fringe image (top right); an intensity plot of the fringe image, inset; middle right, shows the fringes more clearly (integration time is 30 s with 500 mW laser power at the sample) in accordance with certain aspects of the present disclosure;

FIG. 3 depicts a CCl₄ spectrum showing the Stokes and anti-Stokes regions in accordance with certain aspects of the present disclosure; the heterodyne wavelength was changed to 513 nm, allowing both regions to be measured simultaneously (integration time is 30 s with 500 mW laser power at the sample);

FIG. 4 depicts Raman spectra of cyclohexane, toluene, and o-xylene measured using 30 s exposure times with the SHS Raman system in accordance with certain aspects of the present disclosure; the arrows above each spectrum refer to the appropriate intensity axis for that spectrum (laser power: 500 mW at the sample);

FIG. 5 depicts quartz crystal Raman spectra measured using dispersive (D, 15 s integration) and SHS Raman spectrometers (30 s integration and ˜500 mW laser power) in accordance with certain aspects of the present disclosure;

FIG. 6 depicts a solid line: Sulfur Raman spectrum using (A) dispersive Raman spectrometer, and (B) SHS Raman spectrometer with Littrow wavelength set to ˜532 nm (˜0 cm⁻¹), 30 s exposure, and 100 mW laser power; the two bands marked as AS in (B) are anti-Stokes bands that overlap with the 153 and 218 cm⁻¹ Stokes bands. In (B), the intense band at 218 cm⁻¹ (higher energy side of the doublet) and 472 cm⁻¹ are Stokes bands; dashed line: instrument response for the SHS Raman system, measured by fitting a polynomial line to a quartz halogen lamp spectrum;

FIG. 7 depicts Sulfur Raman spectrum using (A) dispersive Raman spectrometer (15 s integration time), and (B) SHS Raman spectrometer with Littrow wavelength set to ˜525 nm (˜−250 cm⁻¹), 30 s exposure, and 100 mW laser power; the two bands marked as AS in (B) are anti-Stokes bands; in B the Stokes bands at 218 cm⁻¹ and 472 cm⁻¹ show artifacts on the low energy side, possibly due to grating imperfections;

FIG. 8 depicts top Image: Sulfur fringe image with Littrow wavelength set to the laser wavelength and one grating tilted to separate Stokes (counter-clockwise tilted fringes) and anti-Stokes (clock-wise tilted fringes) regions; middle image: 2D Fourier transform of top image, zoomed in to show the separation of Stokes (top) and anti-Stokes (lower) bands (two of the Raman bands are labeled in this image; the two Raman spectra are intensity plots of the middle image across the top (Stokes) and bottom (anti-Stokes) parts of the image. Integration time is 30 s with 100 mW laser power at the sample);

FIG. 9 depicts Raman spectra of p-xylene using dispersive (D) and SHS Raman spectrometer with grating tilted to double the spectral range in accordance with certain aspects of the present disclosure; the Littrow setting was ˜1100 cm⁻¹ (notice the anti-Stokes band in the SHS spectrum, integration time is 30 s with 500 mW laser power at the sample);

FIG. 10 depicts SHS Raman spectra of sulfur for focused (˜26 μm diameter) and unfocused (˜2300 μm diameter) laser beams of identical power in accordance with certain aspects of the present disclosure (Littrow is set below the laser line at ˜525 nm to show both anti-Stokes and Stokes regions, integration time is 30 s with 100 mW laser power at the sample);

FIGS. 11-14 depict schematics of SHS Raman spectrometer systems in accordance with certain aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present disclosure is generally directed to systems and methods for spatial heterodyne Raman spectroscopy. In addition, the same or a similar system to that described herein can be utilized for laser-induced breakdown spectroscopy (LIBS) by using a high-peak power pulsed laser. The present disclosure describes a spatial heterodyne interferometer having a design with no moving parts. Spatial heterodyne spectrometers (SHS) have previously been described with designs that are compatible with pulsed laser excitation and offering several advantages including high spectral resolution, limited by the diffraction gratings, in a very small form factor; a large acceptance angle; very high optical etendue and thus high throughput; and demonstrated high resolution in the UV. Applications of spatial heterodyne spectrometers (SHS) outside of astronomy are still relatively few; however, a UV absorption SHS spectrometer has been successfully demonstrated in space. The spatial heterodyne spectrometer has not been used previously for Raman applications, likely because SHS technology has been focused on astronomical remote sensing and because most systems are designed for a very small spectral band pass. As described in the present disclosure, the ability to heterodyne using diffraction gratings (or prisms) in the SHS design provides much higher resolution in the UV and better control over the spectral range. Advantages of the proposed SHS UV Raman system, other than the small size, is no moving parts, making it compatible with a pulsed laser and gated detector, essential for daylight measurements, wide-area detection and wide acceptance angle, large spectral range, high resolving power and thus high spectral resolution, and high optical throughput.

In accordance with the present disclosure, a SHS Raman spectrometer (also referred to herein as SHRS) can be utilized for Raman measurements on liquid, solid, and gas samples using visible (532 nm), near-infrared, UV, or deep-UV laser excitation.

Raman is a vibrational spectroscopic technique where a laser or other monochromatic light source is used to excite a sample to be measured, and Raman photons are collected to generate the Raman spectrum, which is a plot of Raman scatter intensity versus energy relative to the laser energy or Raman shift in units of wavenumbers, cm⁻¹. Raman photons can be shifted to higher energy versus the laser photon energy (e.g., anti-Stokes scattering) or shifted to lower energy than the laser energy (e.g., Stokes scattering). A monochromator is typically utilized to disperse the Raman scattered light before it is collected by a detector, usually a charge-coupled device (CCD). In FT Raman, a Michelson interferometer is used rather than a monochromator. A Michelson is a moving mirror interferometer. Stationary, tilted-mirror interferometers have also been used for Raman.

The disclosed SHS Raman spectrometer has many unique advantages over all previously-reported Raman spectrometers. For instance, the SHS has the following advantages over a monochromator (MC) for Raman; much higher etendue or throughput, wide-area collection capability, much higher resolving power in a much smaller and lighter package, much larger input aperture compared to MC slit.

Further, the SHS has the following advantages over a Michelson interferometer (MI) for Raman; no moving parts in SHS allows using a pulsed laser and gated detector so it can be used in ambient light conditions, and so an entire Raman spectrum can be acquired with each laser pulse. This also allows a pulsed laser to be used to “freeze out” vibrational instabilities in the SHS. SHS also allows heterodyning around the laser wavelength to increase the resolution in the deep UV. SHS gives higher resolving power in the deep UV using much lower tolerance optics. SHS allows the use of simple wedge prisms to further increase the acceptance angle, which is very difficult and not practical in a moving mirror design.

The SHS also has the following advantages over tilted-mirror interferometer (TMI) such as the Sagnac design for Raman; gratings allow simple optical heterodyning and higher UV resolution. Littrow wavelength setting allows elimination of spectral regions outside the region of interest and higher resolution, and a lower number of samples can be used while still maintaining high spectral resolution.

The disclosed SHS Raman is implemented differently than all prior applications of the SHS spectrometer. At a minimum, SHS Raman requires an active, monochromatic excitation source, an appropriate laser light rejection filter at the entrance to the SHS, appropriate band pass filters to eliminate any light that is at wavelengths outside the Raman range, and setting the gratings angle (e,g, Littrow wavelength) to the laser wavelength or another appropriate wavelength so that the Raman shifted wavelengths produce fringes that are within the range of the CCD detector.

Beyond this minimal implementation, certain embodiments can include one or more of certain refinements. For example, a pulsed laser and gated detector can be utilized to eliminate ambient light, and a pulsed laser can be used to “freeze out” vibrational instabilities in the SHS. The grating angle and distances can be adjusted to minimize laser scattered light from reaching the detector. The Littrow wavelength can be set at an intermediate Raman shift so that Stokes and anti-Stokes Raman bands can be measured simultaneously. Tilting one grating vertically and using a 2D Fourier transform can allow Stokes and anti-Stokes to be measured simultaneously, or this technique can be used to double the spectral range for a given CCD or ICCD detector. One application of the present disclosure is Raman thermometry where the S/AS ratio is a measure of sample temperature. The SHS Raman makes this easier to measure than some other Raman spectrometers. The gratings can be mounted on piezoelectric positioners or other micropositioners to allow fine tuning of Raman bands and further discriminate S and AS bands.

SHS Raman is ideal for deep-UV laser excitation. The very high resolving power of the SHS makes it possible to excite Raman in the deep-UV while still providing high resolution and a large Raman spectral range. Deep UV excitation, wavelengths below the about 250 nm range, has many advantages for Raman. Raman scatter efficiency is proportional to Raman frequency to the fourth power, so shorter laser wavelengths produce much higher Raman signals. UV excitation also provides the opportunity to achieve resonance Raman which also greatly increases sensitivity. Using deep-UV excitation and appropriate band pass filtering in the SHRS also eliminates sample fluorescence, which occurs at longer wavelengths.

SHS can also be utilized for pure rotational or ro-vibrational Raman measurements. This is possible because of the high resolving power but also because the Littrow wavelength can be precisely set to maximize elimination of the laser line or of a strong vibrational band. One application of this is Raman thermometry where the ratio of rotational band intensities is a measure of sample temperature. The SHS Raman simplifies this measurement.

A spatially extended light source, such as a light emitting diode (LED), can be utilized in connection with SHS Raman. An LED cannot be focused to a small spot because the light comes from a diffuse source. The wide-area collection ability of the SHS Raman makes it possible to take advantage of the large spot size of this source.

Standoff Raman with the SHS has been demonstrated and that there is no need for accurate alignment of the SHS with the sample because of the wide-area collection ability. This also makes it easier to couple the SHS Raman with a telescope or other optic that can be used to increase the standoff Raman signal.

One application of standoff SHS Raman is planetary lander/rover measurements where the wide-area collection capability of the instrument allows large areas of the surface to be measured quickly with no loss of spectral resolution. Another application of SHS Raman is detection of high explosives (HE) materials remotely (e.g., standoff). The wide-area capability is useful for scanning large areas quickly. The high light throughout allows high sensitivity SHS Raman measurements and thus the ability to measure small amounts of HE.

Standoff Raman can be utilized for detecting HE and HE materials and residues for the detection of improvised explosives devices. The SHRS offers superior performance for such applications because of the high light throughput, the ability to measure wide-area samples, and the high spectral resolution in a small rugged package.

The SHRS can be utilized as a chemical sensor in chemical reaction monitoring, in-situ characterization, batch processing and adaptive manufacturing processes. In these applications sensors are included in the manufacturing process loop to determine effectiveness of the process ion real time. Sensor outputs are processed by the manufacturing process computer and used to control effectors in a control loop to continually refine the manufacturing process. A small, miniature Raman system in the form of a miniature Raman microscope could be used as the sensor in such a process but in this case Raman images would contain chemical information as well as spatial and temporal distribution of the chemicals and products in the reaction. Raman spectra are superior to other spectroscopies such as IR for different applications like polymer reactions. The SHRS is superior to existing Raman microscopes for this application because it can be made extremely small while still providing sufficient spectral resolution to monitor chemical reactants and products during the manufacturing process. Along with a diode laser excitation source and line CCD or other small CCD the entire instrument can be made extremely small. Hand held or smaller, miniature Raman spectrometers are contemplated in accordance with the present disclosure as chemical sensors using the SHRS design.

The SHS also allows the measurement of light sensitive materials. This is possible because the wide-area collection capability of the SHS allows much large laser spots to be used at the same laser power. Thus photo-induced damage is reduced while the Raman signal is not effected. Some HE such as TNT are photo-sensitive. The laser can degrade the sample while it is being measured. SHS Raman can eliminate this problem.

The large acceptance aperture makes it easy to couple fiber-optics with the SHS. Fiber-optic collection can be used to route optical signals to an SHS Raman spectrometer that is at some remote distance, or not in a line-of-site, from the sample. The use of an optical fiber bundle to couple the SHS fringe image to a CCD detector is also possible.

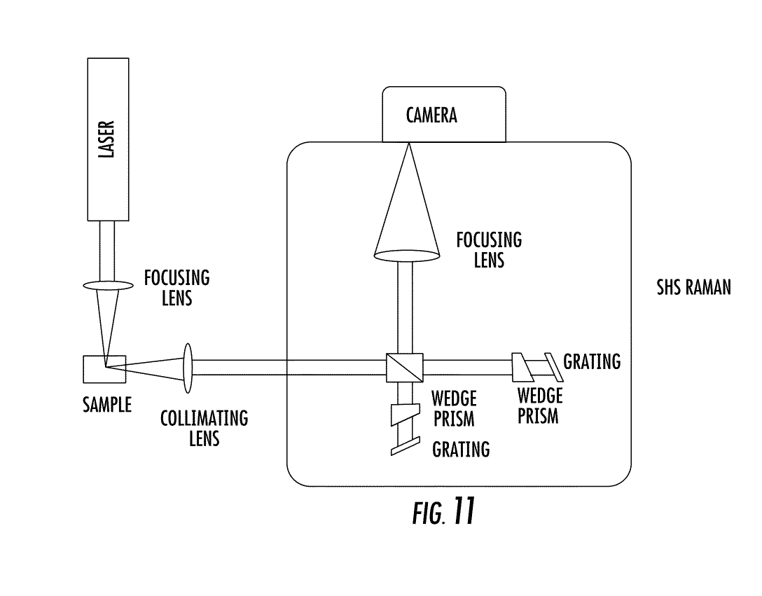

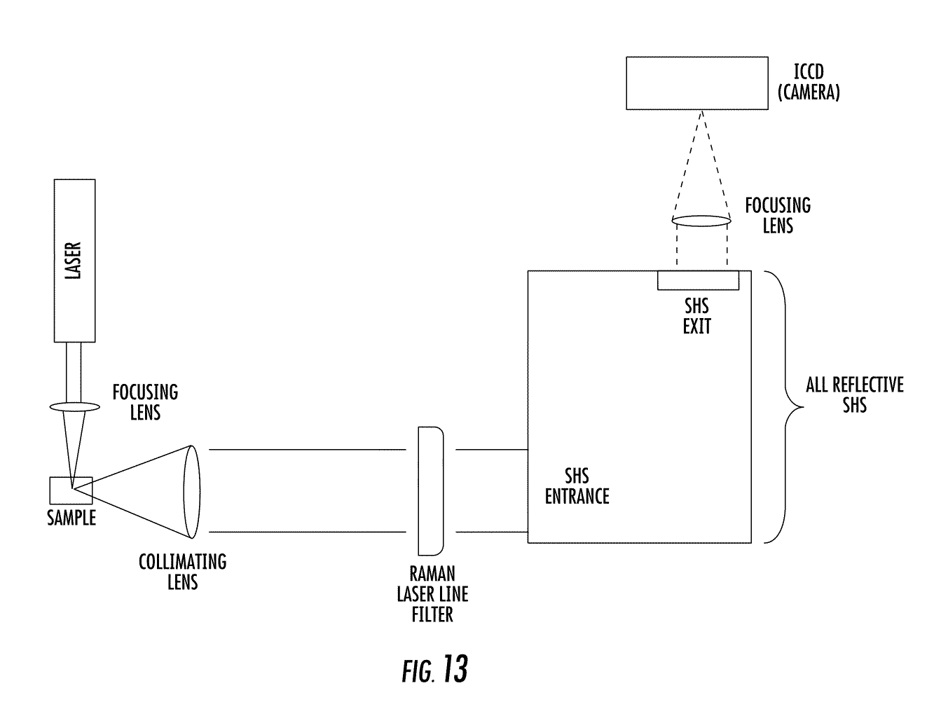

Referring to FIGS. 11-13, exemplary SHS Raman imaging systems are illustrated. The SHS can accommodate cylindrical lenses placed between the wedge prisms and the gratings to form an image of the sample on the face of the grating, orthogonal to the fringe direction (which is typically vertical). Line imaging may also be achieved by forming an image of the source on the diffraction gratings by adjusting the focus of the collection optic.

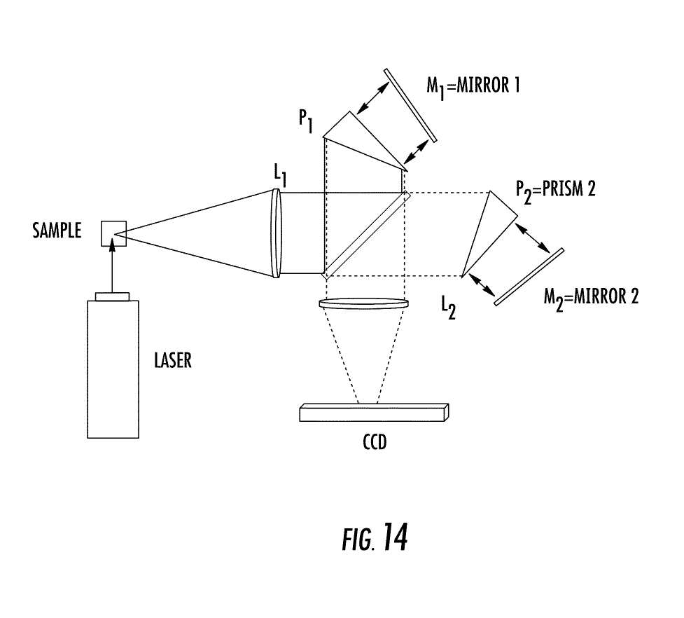

Turning to FIGS. 11 and 14, the addition of low-dispersion wedge prisms between the beam splitter and the diffraction gratings increases the acceptance angle of the SHS Raman spectrometer. A typical acceptance angle without the wedge prisms is about 0.5-1°, while the acceptance angle with the wedge prisms is about 5-10°. The advantages of the prism include no order overlap as with gratings, less diffusely scattered light of the type seen with gratings, and the prisms make it easier to get a moderate resolving power in the deep UV spectral range.

In this manner, the SHS Raman spectrometer of the present disclosure will allow measurements of large-area samples. Measuring large-area samples is important because it provides the ability to quickly measure Raman spectra over a wide area (e.g., a room, a car door, or the like, when trying to detect high explosives residues or blood stains), and allows the use of an expanded laser beam at the sample. Raman is traditionally done by focusing the laser to a small spot on the sample so that light from the small spot can be collected and reimaged onto a small slit in a dispersive spectrometer. The slit in a dispersive spectrometer determines the spectral resolution, and spectral resolution needs to be high for Raman, especially in the deep UV, and small slits (e.g., about 10-100 microns wide) limit the size of the laser spot on the sample. Small spots can mean greater chance for sample damage such as laser-induced photo- or thermal-sample degradation. In accordance with the present disclosure, there is no slit, instead there is an aperture typically about 25-mm in diameter and the acceptance angle is large. Together this allows the SHS to accept light from wide areas of the sample so that the laser can be expanded to fill a large area. With the same amount of laser power (Watts) either size spot gives the same amount of scattered light. For laser-sensitive samples (most real samples) using a large spot the laser radiance (W/cm²) is smaller on the sample and thus sample degradation is reduced or eliminated. Thus, the described wedges allow even larger samples to be illuminated and measured with no loss of Raman signal or spectral resolution, but a tremendous reduction in sample degradation.

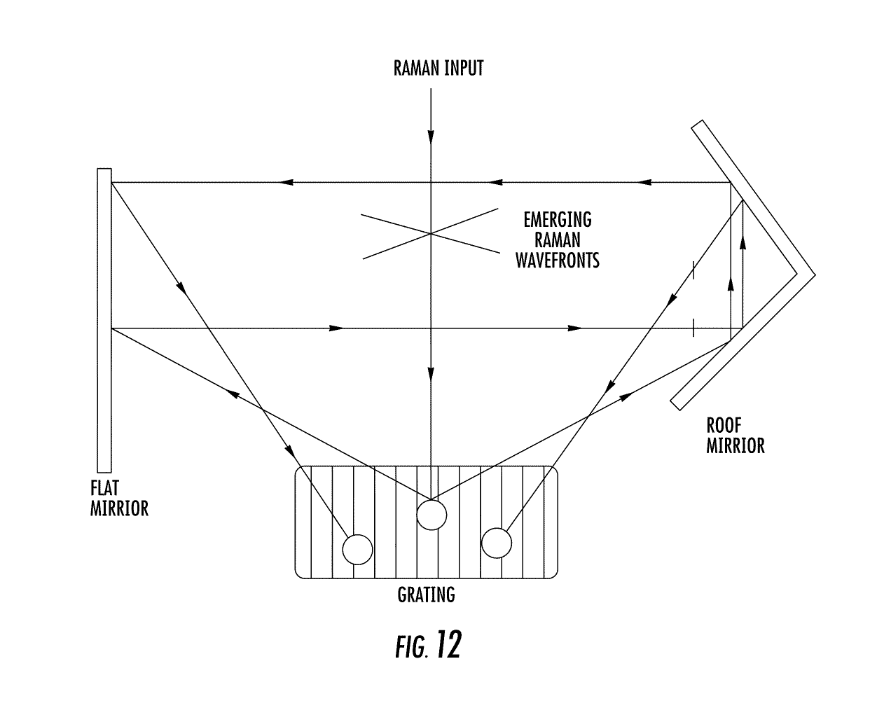

Turning to FIG. 12, an all reflective SHS Raman spectrometer can be made using all-reflective optics as illustrated. A flat mirror and roof mirror are configured around a single diffraction grating. The diffraction grating splits the incoming Raman scattered light into two arms (plus and minus orders of the grating) that travel in opposite directions between the mirrors. The grating is slightly tilted so that the two beams emerge slightly offset from the incoming beam. All-reflective optics are useful in that they are compatible with all wavelengths, even deep UV. Transmissive optics like beam splitters, lenses, and filters have wavelength dependent transmission and thus must be optimized or selected for each wavelength range. This is especially difficult in the deep UV, below about 250 nm, where it can be difficult to find high quality UV transmitting optical components. The all reflective design of the present disclosure avoids the issue because mirrors reflect over a wide range of wavelengths including the deep UV.

As mentioned herein, SHS has been previously described to measure wide area diffuse stellar emission. SHS has also been used for absorption measurements. SHS has unique characteristics which include high optical throughput (e.g., large etendue), wide acceptance angle which gives the ability to measure wide-area, extended sources of light, very high resolving power, R, which is defined as the ratio of the measured wavelength to the full-width half maximum of a monochromatic source at that wavelength (e.g., spectral resolution), large entrance aperture as opposed to a monochromator slit which gives very large optical throughput, small size in proportion to the resolving power, and no moving parts.

The present disclosure can be better understood with reference to the following examples.

### EXAMPLES

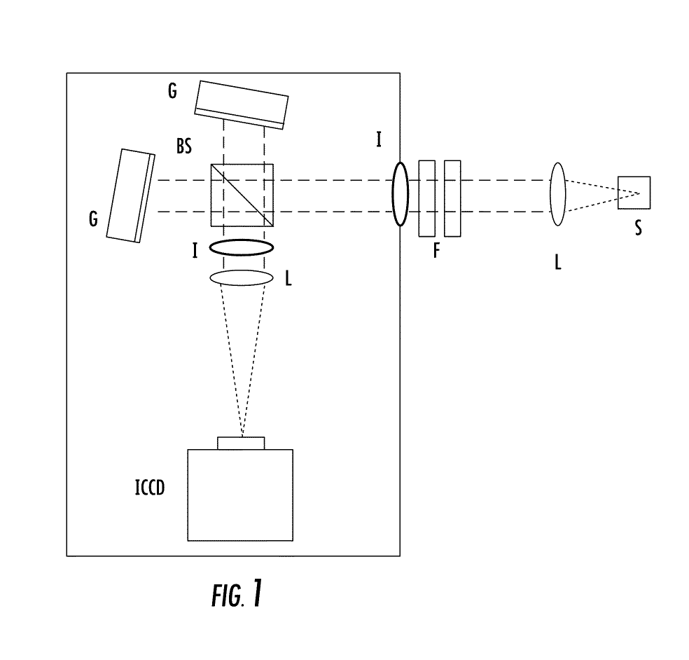

A schematic of the experimental setup is shown in FIG. 1. The SHS Raman spectrometer follows the design of a basic spatial heterodyne interferometer, modified for Raman by the inclusion of holographic laser line rejection filters. The spatial heterodyne spectrometer (SHS) includes a 25-mm quartz beam splitter; two 25-mm-square, 150 grooves/mm diffraction gratings; and a 40-mm diameter, 140-mm-focal-length detector focusing lens placed one focal length from the detector (Princeton Instruments ICCD-MAX 1024×256) and one focal length from the grating virtual images, providing a fringe image that was about 25 mm in height at the 6.7-mm-high intensified charge-coupled device (ICCD) detector. Two holographic laser line rejection filters (Kaiser 532 nm Supernotch) provide 10¹² rejection at the laser wavelength. Scattered light was collected from the sample using a 40-mm-diameter, 70-mm-focal-length lens. This lens also served to collimate and direct the collected light into the interferometer through a 25-mm-diameter aperture. The interferometer Littrow wavelength (i.e., grating angle) was set using either the laser line or the narrow lines from a low-pressure mercury or xenon lamp. Liquid samples were placed in a 1-cm quartz cuvette, centered at the focal length of the collection lens and the laser focus. Solid samples were illuminated in the same way but were mounted on a small stage with x,y,z-axes position adjustments. The 532-nm continuous wave (CW) laser (Spectra-Physics Millenia Pro) was operated at power levels ranging from 100 mW to ˜500 mW at the sample. Fringe images were acquired using the 1024×256 pixel detector. Two background images used for background corrections were acquired by blocking each grating path. Fourier transforms of the fringe cross-sections were performed using the fast Fourier transform (FFT) routine in Matlab (1D FFT) and two-dimensional Fourier transforms (2D FFT) of fringe images were performed using IPLab; all transformed images and spectra are shown without any further processing. All indicated integration times were performed by summing one-second co-additions. No flat-field, instrument response, smoothing, or other processing was used on the data shown. For comparing SHS-generated Raman spectra with those from dispersive-based systems, Raman spectra were also measured using a Jobin Yvon Horiba LabRaman III micro-Raman system with a 50-mW CW 532-nm laser, with an 1800 grooves/mm grating and a 100-μm aperture, at 4.1 cm⁻¹ spectral resolution.

In the SHS Raman spectrometer, the Raman scattered light is collected and collimated, then filtered by the two holographic filters to remove laser scatter from the Raman signal. The filtered, collimated light passes through a 25-mm aperture into the SHS. Light entering the SHS is split into two beams by the 50/50 beam splitter. The separated beams strike the tilted diffraction gratings, are diffracted back along the same direction, re-enter the beam splitter, and recombine. The grating tilt angle defines the Littrow wavelength, Δλ, the wavelength at which both beams exactly retro-reflect, producing no constructive or destructive interference and therefore no fringe pattern at the detector. For any wavelength other than the Littrow, the recombined light produces a crossed wave front, of which the crossing angle is wavenumber dependent, and produces an interference pattern at the interferometer output,4,5 which is the Fourier transform of the spectrum. The interference pattern is imaged onto the ICCD to produce an image of vertical fringes. The number of fringes, f, across the ICCD is related to the Littrow wavenumber by Eq. 1:

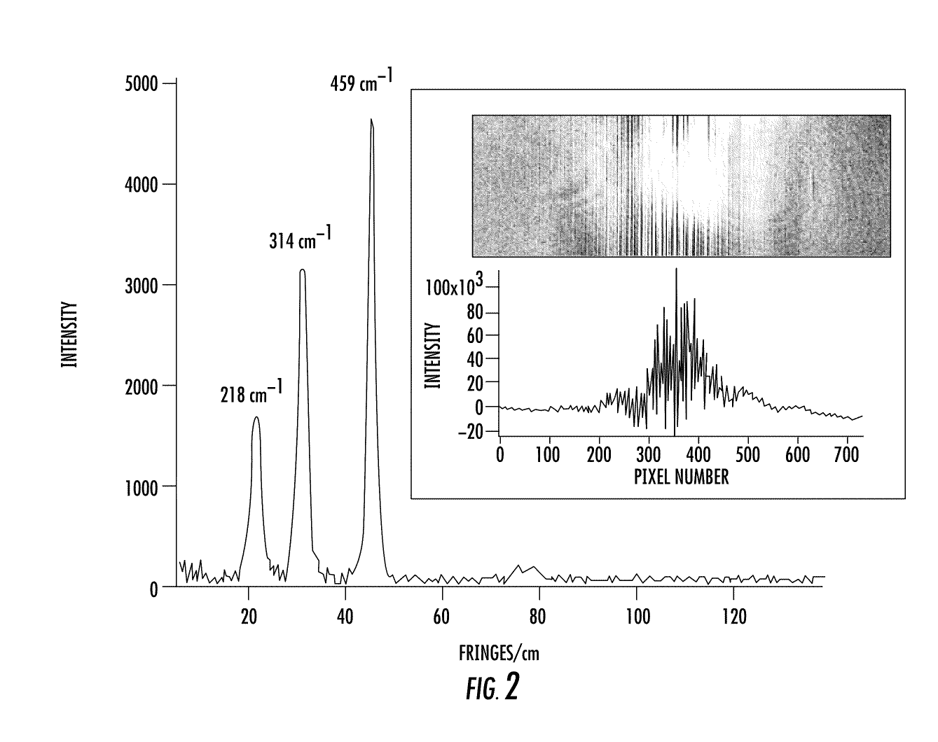

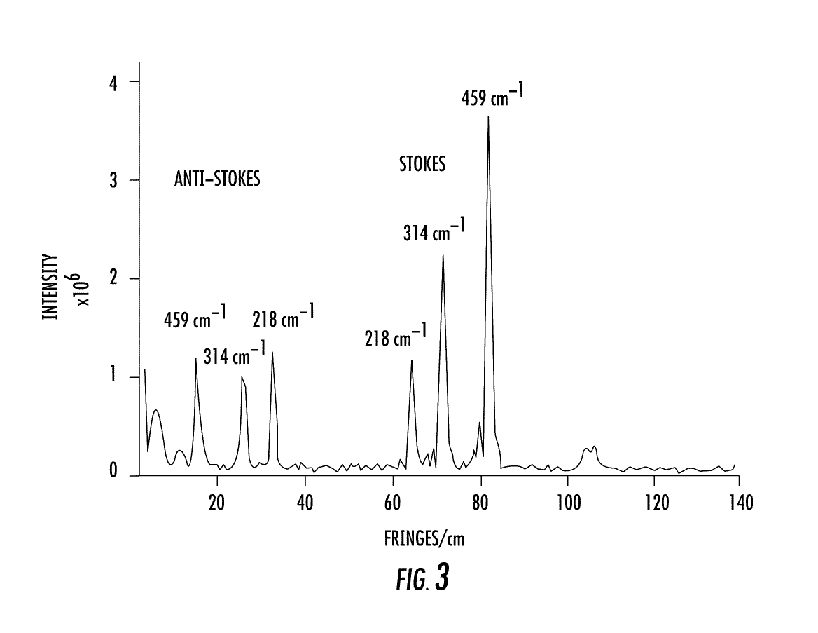

f=4(σ−σ_{L})tan θ_{L}

where f is in fringes/cm, σ is the wavenumber of interest, σ_{L} is the Littrow wavenumber, and θ_{L} is the Littrow angle. Bands with larger wavenumber shifts produce more closely spaced fringes. Because of the symmetry in this equation, spectral features at wavenumbers both higher and lower than Littrow overlap on the detector. In the case of Raman spectra, this can cause overlap of Stokes and anti-Stokes bands if the Littrow wavelength is set near the laser excitation wavelength. However, this overlap can be avoided by tilting one grating, producing a rotation of the fringe pattern clockwise for bands at wavenumbers below the Littrow wavelength and counterclockwise for bands above Littrow. The resolution of the SHS spectrometer was determined by using a low-pressure mercury lamp and measuring the average full width at half-maximum (FWHM) of the 576.95-nm and 579.06-nm Hg lines. The resolution calculated in this way was ˜0.35 nm (9.4 cm⁻¹). The mercury line wavelengths are close to the wavelength of Raman scatter ng using 532-nm laser excitation and thus 9 cm⁻¹ is a good estimate of the resolution of the SHS Raman instrument. The resolution is a little more than the theoretical resolution of ˜2.5 cm⁻¹ that is predicted if we assume the resolving power, R, is equal to the number of grooves illuminated (R=150 grooves/mm*2 gratings*25 mm=7500). The lower resolution has not yet been fully investigated but possible reasons include gratings not being fully illuminated, collected light not properly collimated or entering the interferometer off-axis, interferometer beam alignment, and imperfect focusing by the imaging lens, the latter being the most probable cause. FIG. 2 shows a fringe image, the image cross-section, and a Raman spectrum (plotted as Raman scattering intensity versus fringes/cm, f) that was generated by taking a one dimensional (1D) Fourier transform of the fringe cross-section for carbon tetrachloride (CCl₄). Littrow wavelength was set very near the laser wavelength. Several experiments were performed to ensure that the fringes/cm as shown in Eq. 1 was linear with Raman shift. The relative intensities of the three main Raman bands are approximately correct even though no attempt was made to correct for the instrument function. For the 459 cm⁻¹ band the limiting resolution is 18 338 cm⁻¹/7500=2.4 cm⁻¹. The circular fringe patterns seen in the fringe image were caused by interference from lenses in the interferometer. The patterns sometimes lead to artifact peaks located on the side of weak Raman bands, especially when the one-dimensional (1D) Fourier transform process was used on the fringe cross-sections. In some cases the Raman spectrum was generated by first taking a 2D Fourier transform of the fringe image, then taking an intensity cross-section of the transformed image. Artifact peaks were less noticeable for 2D Fourier transform-processed images (shown below). The CCl₄ spectrum shown in FIG. 2 includes both Stokes and anti-Stokes Raman bands though they almost completely overlap because of the Littrow wavelength setting. FIG. 3 shows another CCl₄ spectrum but in this case the Littrow wavelength was set to a wavelength shorter than the 459 cm⁻¹ anti-Stokes band (˜513 nm) so that the Stokes and anti-Stokes regions are well separated. The resolution of the 459 cm⁻¹ band is 15 cm⁻¹, slightly better than seen in FIG. 2, likely because there is no longer spectral overlap of the Stokes and anti-Stokes bands. Further evidence of Stokes, anti-Stokes band overlap is seen in the relative intensities of the Stokes bands, most noticeably the weak band around 770 cm⁻¹, which is about twice the relative intensity expected since anti-Stokes band overlap would be greatest for the lower frequency bands. The relative intensity of the 314 cm⁻¹ band is also higher in FIG. 2, as would be expected if the anti-Stokes and Stokes regions overlap. The slight shoulder on the low-energy side of the 459 cm⁻¹ band is due to the well-known ³⁵Cl and ³⁷Cl isotopic shifts. However, this band might also be partially broadened due to anti-Stokes overlap. Anti-Stokes overlap is certainly the reason for the broadening of the 218 cm⁻¹ band in FIG. 2: 25 cm⁻¹ FWHM in FIG. 2 but only 15 cm⁻¹ in FIG. 3. The resolution is very sensitive to the focus of the fringes on the ICCD as well as to the distance of the focusing lens from the interferometer gratings. In the system described here adjustment of the ICCD position was fairly crude and this may partially explain why the measured resolution was not as good as predicted.

Overlap of the Stokes and anti-Stokes regions using the SHS Raman spectrometer is an issue mainly for low-frequency Raman bands where thermal population is highest. There are several simple ways to prevent unwanted overlap of these two regions, including optical filtering with a long-pass or bandpass filter, careful selection of the Littrow wavelength, or tilting one of the two gratings in the vertical direction. During the studies reported here, the appropriate long-pass filter was not available to block the low-energy anti-Stokes bands. However, FIG. 3 demonstrates the heterodyning capability of the SHS by selecting the appropriate Littrow wavelength to display both Stokes and anti-Stokes regions simultaneously. It has also been shown that the band pass of an SHS spectrometer can be doubled by setting the Littrow wavelength to the middle of the wavelength range of interest and separating the two sides, in this case the anti-Stokes and Stokes regions, by tilting one of the diffraction gratings vertically.

No attempt was made to compare the signal-to-noise ratio (S/N) of any of the SHS Raman spectra shown to a dispersive Raman system, and the integration times used were relatively long because the optics in this system were far from optimal in this “proof of concept” spectrometer. Also, the S/N would not necessarily be expected to be better for most of the spectra shown, where the laser was tightly focused on the sample, and the S/N might even be worse for some bands because of the way the noise is equally distributed in an interferometer-based spectrometer. Where a S/N improvement might be expected is for measurements where the laser spot is very large such as standoff applications, or applications in which the laser beam is defocused to achieve a low laser flux on the sample.

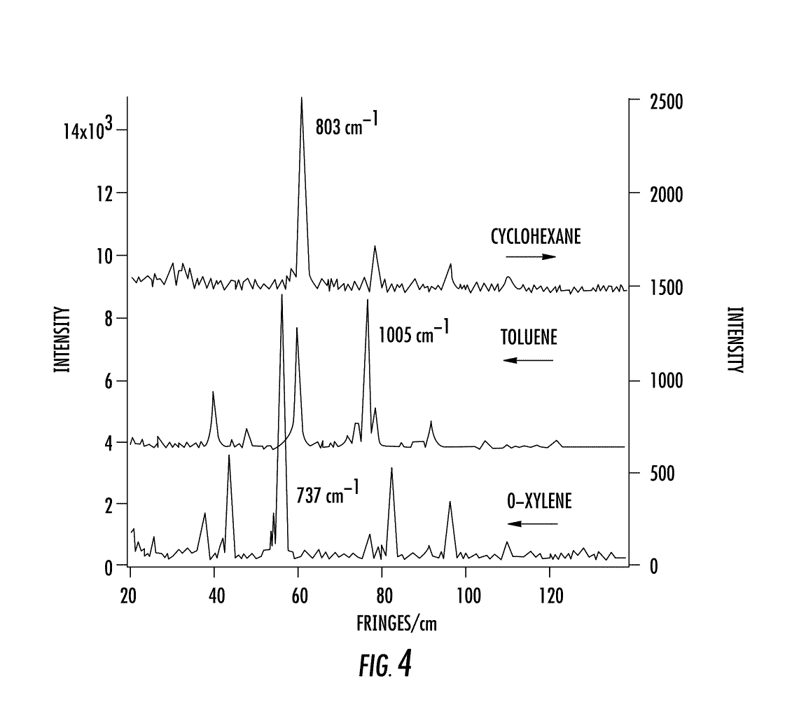

FIG. 4 shows Raman spectra of three other liquids, cyclohexane, toluene, and o-xylene, to demonstrate the useful spectral range of the SHS Raman spectrometer using the 25-mm, 150 grooves/mm gratings and the 1024 channel ICCD; the observed range in this grating configuration is about 2000 cm⁻¹, though this range is much larger in the configuration described below. This is actually larger than would be expected for a resolving power of 7500 and is evidence that the experimental resolving power is less than the theoretical resolving power. The band pass of the SHS is determined by the resolving power and the number of pixels, N, in the horizontal direction (i.e., x-axis) on the ICCD. The Nyquist limit sets the highest frequency that can be measured by the ICCD to N/2 fringes or 512 in this case. With a resolving power of 7500 the smallest wavenumber increment at 532 nm (18797 cm⁻¹) would be 2.5 cm⁻¹ (18797 cm⁻¹/7500), corresponding to a 1283 cm⁻¹ (512 fringes×2.5 cm⁻¹) total spectral range or band pass, lower than what is actually observed. The spectral range can be extended by using a detector with more horizontal pixels or by reducing the resolving power. It can also be approximately doubled by tilting one of the diffraction gratings vertically as previously described above.

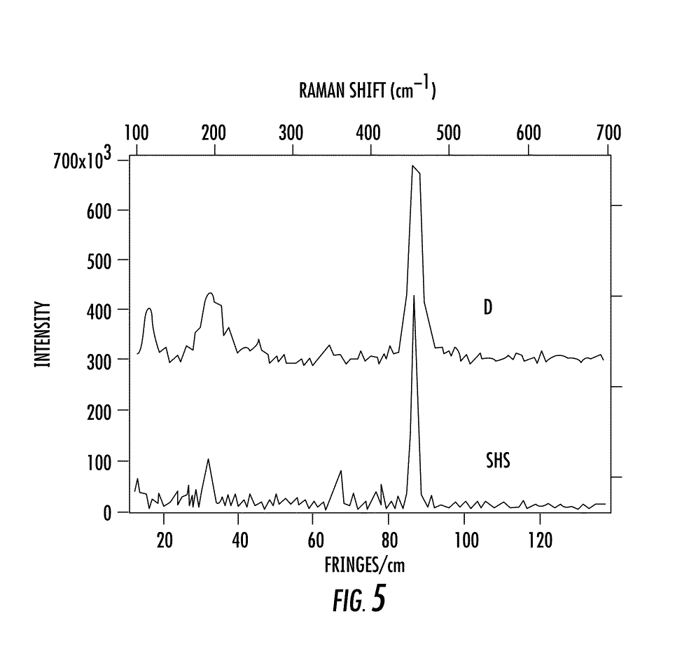

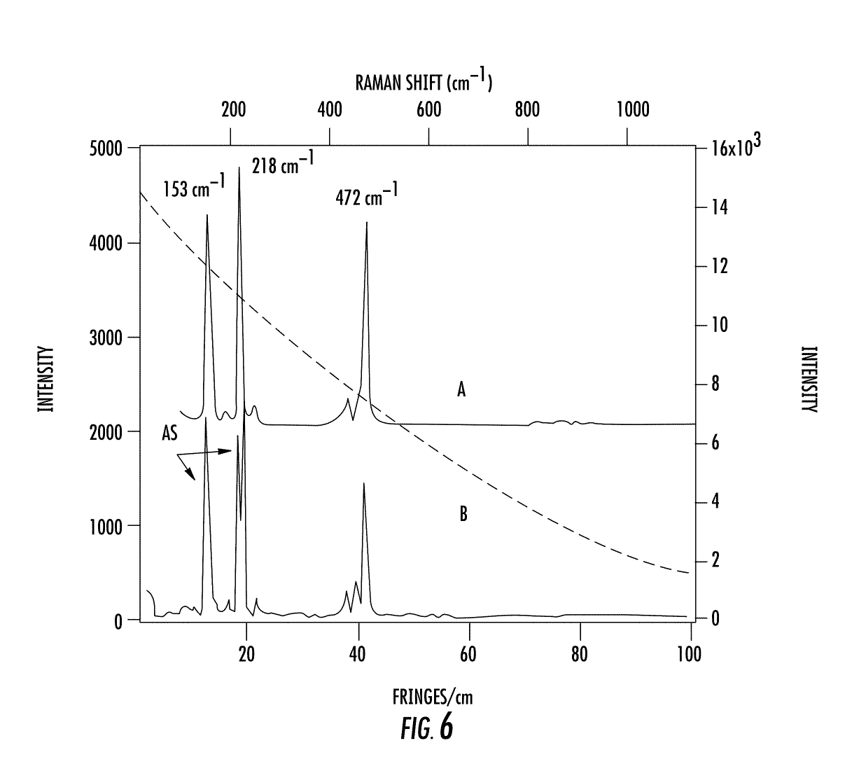

FIG. 5 shows Raman spectra of α-quartz crystal acquired with a dispersive system (D) and the SHS Raman spectrometer. These spectra show clearly that the resolution of the SHS spectrometer, using 25-mm, 150 grooves/mm gratings, is competitive with the spectral resolution of a high-performance f/4 dispersive system having an 1800 grooves/mm grating. FIG. 6 shows the instrument response of the SHS system, measured using a quartz halogen lamp (dashed line). The drop-off in system response is the result of decreasing beam overlap at wavelengths far from Littrow. FIG. 6 also shows Raman spectra of sulfur using (A) a dispersive Raman spectrometer and (B) the SHS Raman spectrometer with the Littrow wavelength set to ˜532 nm (e.g., at the laser-excitation wavelength), which corresponds to ˜0 cm⁻¹ in the Raman spectra shown. In the SHS-acquired spectrum, a 600-nm short-pass filter and a 515-nm long-pass filter were used in the interferometer to limit the bandpass and minimize noise. In the interferometer, noise at all wavelengths is distributed equally throughout the spectrum. Using the low noise ICCD detector, the SHS Raman spectra were background limited. The spectral resolutions of both spectra are nearly the same, as is the noise when both spectra are examined at a strong Raman band. Note: noise in the baseline should not be used for comparison as the noise is distributed differently in the two different instruments.

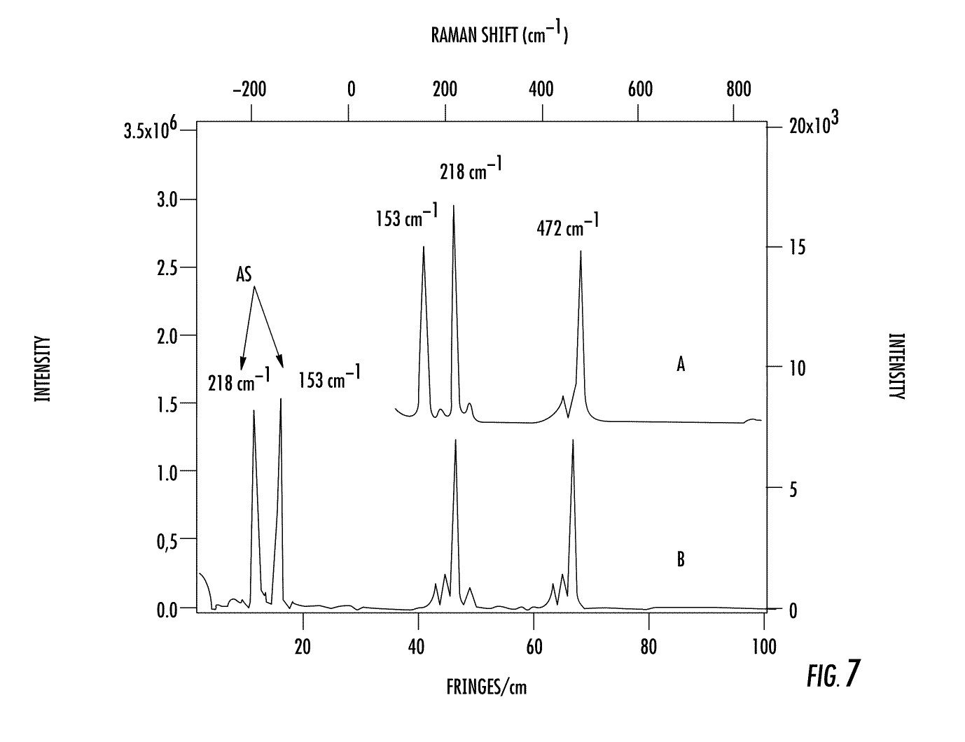

In the SHS spectrum of FIG. 6, two strong anti-Stokes bands overlap with the 153 cm⁻¹ and 218 cm⁻¹ Stokes bands. In the Stokes region the 153 cm⁻¹ band is blocked by the holographic notch filter so that only the anti-Stokes 153 cm⁻¹ band is seen. In the case of the 218 cm⁻¹ band, both Stokes and anti-Stokes bands are observed and almost completely overlap in this spectrum—the anti-Stokes band is just slightly to the left of the Stokes band. The 472 cm⁻¹ band shows a low-energy shoulder in both spectra. However in the SHS spectrum this shoulder shows high-frequency artifacts that seem to be the result of imperfect diffraction gratings or other uncorrected optical aberrations in the interferometer. These artifacts show up in the SHS spectra for any bands that are shifted far away from the Littrow wavelength, thus producing a high-frequency fringe pattern. The highest frequency fringes would be expected to be more sensitive to optical aberrations than low-frequency fringes. FIG. 7 also shows Raman spectra of sulfur using the (A) dispersive and (B) SHS spectrometers, but in this case the SHS spectrum was measured with the Littrow wavelength set to about 525 nm, ˜250 cm⁻¹ below the laser line, to separate the Stokes and anti-Stokes Raman bands. The dispersive spectrum only shows the Stokes region. As expected, the 153 cm⁻¹ and 218 cm⁻¹ anti-Stokes bands are clearly separated from the Stokes region, and the 153 cm⁻¹ Stokes band is not observed because it is blocked by the holographic filter. The strong 218 cm⁻¹ Stokes band is observed and it shows low-energy artifact peaks, which were not seen in FIG. 6.

In all of the Raman spectra described above, wavenumbers above and below the Littrow wavelength overlap on the ICCD fringe image. This is not a serious issue for Raman unless low energy bands are measured where there is strong Stokes and anti-Stokes overlap. Overlap can be prevented by using filters to block the anti-Stokes region, but the filter would require a very sharp off-on transition and a different filter would be needed for each laser-excitation wavelength used. An alternative is to separate spectral regions above and below the Littrow wavelength by tilting one of the diffraction gratings vertically. This causes the fringe image to rotate clockwise for wavenumbers below Littrow and counter-clockwise for wavenumbers above Littrow. A 2D FFT of the resulting fringe image is used to retrieve the two spectral regions independently. This has the effect of doubling the useful spectral range for a given ICCD or CCD.

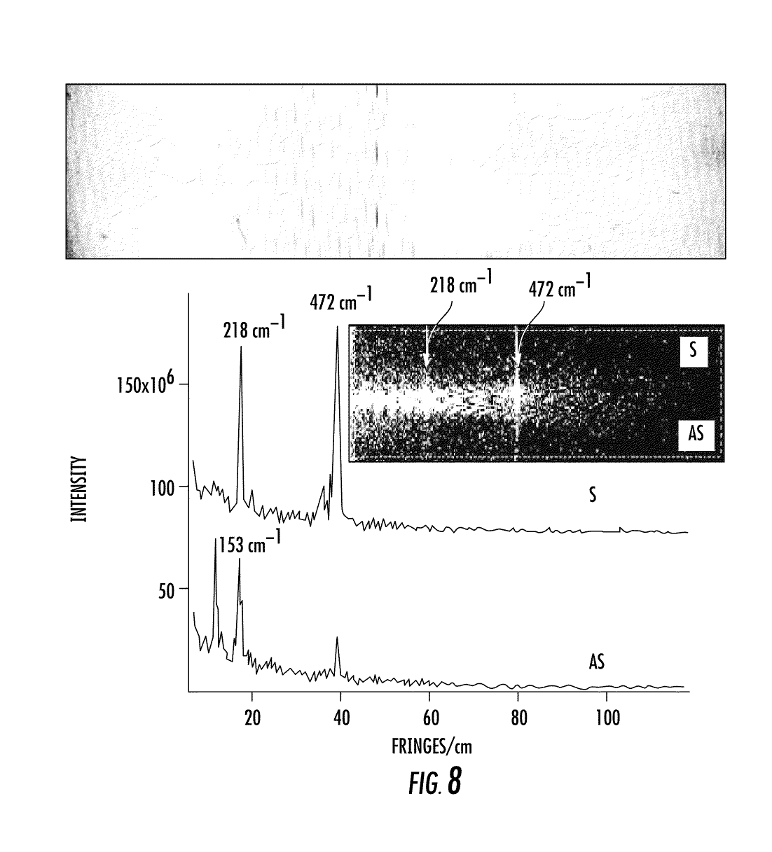

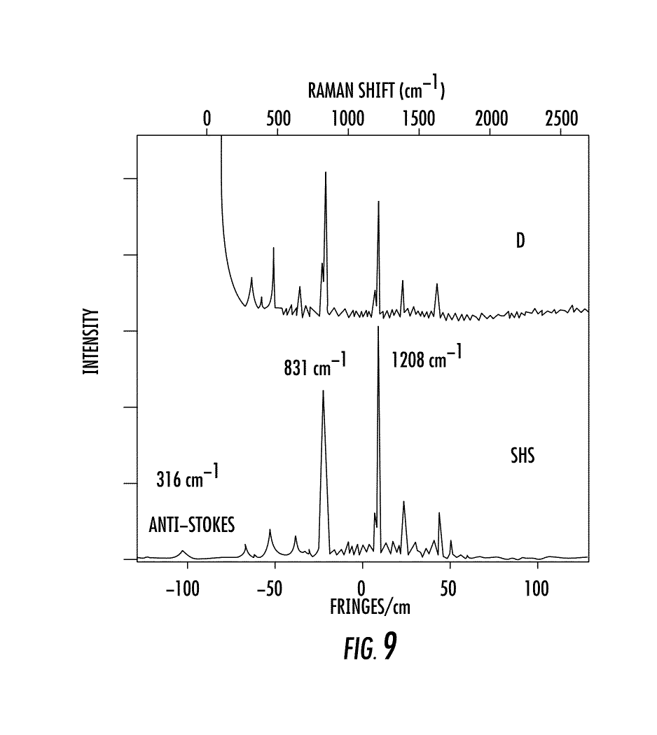

FIG. 8 (top) shows a fringe image for sulfur with the Littrow wavelength set to 532 nm and with one of the gratings tilted vertically. This image clearly shows the crossed fringe pattern that results from the Stokes and anti-Stokes fringe patterns being rotated in opposite directions. The lower inset image (zoomed into the bands of interest) was produced by taking a 2D FFT of the fringe image. Two bands at 218 cm⁻¹ and 472 cm⁻¹ are observed as vertically spaced bright spots. The upper spots are due to Stokes scattered light and the lower spots are anti-Stokes. An intensity plot across each region produces the anti-Stokes (AS) and Stokes (S) Raman spectra, cleanly separated. Tilting the grating has the effect of doubling the spectral range that can be measured with the SHS system. FIG. 9 shows the SHS Raman spectrum of p-xylene using the tilted grating technique to double the useful range. For this measurement the Littrow wavelength was set between the two strongest bands at 831 cm⁻¹ and 1208 cm⁻¹. Bands below Littrow (negative f, fringes/cm) produced fringes that were rotated clockwise and bands above Littrow rotated the fringes counter-clockwise. A 2D FFT analysis was used to separate the two spectral regions as shown in the spectrum. For comparison a Raman spectrum of p-xylene using the dispersive system is also shown.

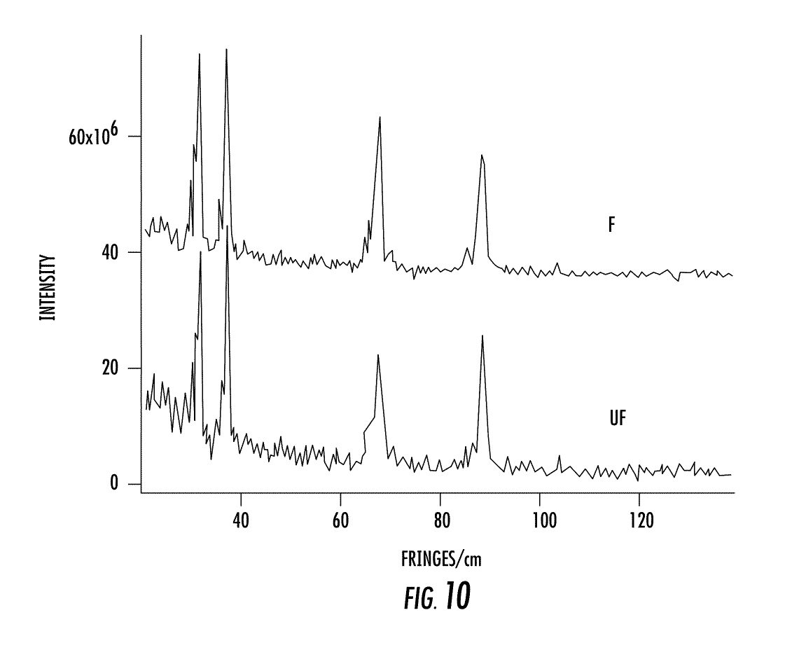

One of the advantages of using an interferometer for Raman is the absence of an input slit and the SHS design has a relatively large acceptance angle, allowing a much larger sample region to be measured without loss of spectral resolution or throughput. This is demonstrated for the SHS system by the spectra in FIG. 10. In this figure, Raman spectra of a sulfur sample, ˜10-15 mm in diameter, are compared using a 26-μm laser spot size (focused, F) and a 2300-μm laser spot size (unfocused, UF). The spectra were otherwise taken under identical conditions without moving the sample. The spectra are almost identical both in terms of spectral resolution and band intensity. This is because the large entrance aperture of the interferometer allows a much larger area of the sample to be measured, unlike the narrow entrance slit of a dispersive monochromator, which limits the sample area that can be viewed. There is also slightly more noise in the unfocused spectrum, likely because the overall background signal was almost twice as high as the focused spectrum. This feature of the SHS Raman spectrometer makes it well suited to measuring Raman spectra of photosensitive compounds since the laser power density can be much lower without loss of spectrometer sensitivity, ˜7800 times lower in this example. The large acceptance angle and large aperture also makes the system ideally suited for measuring large areas simultaneously for applications where large areas need to be screened quickly.

A Raman spectrometer using a high-etendue spatial heterodyne interferometer has been demonstrated by measuring Raman spectra of several liquid and solid samples. Although the high etendue of this system should provide high light throughput, overall sensitivity and light throughput were not measured in this preliminary study because the overall setup was far from optimal in this respect. For example, the fringe image on the detector was about 25 mm high while the detector was only 6.7 mm so at a minimum, not including any other losses, 75% of the Raman scattered light was lost at the detector. In addition, non-anti-reflective optics and inexpensive ruled gratings were used for these preliminary studies. However, it was demonstrated that Raman spectra of sulfur using an unfocused 2.3 mm laser spot produced similar band intensities as the use of a 26-μm laser spot, illustrating the large area measurement capability of the SHS Raman design.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A device comprising:
an excitation source configured to illuminate a sample with wavelengths; and
a spatial heterodyne interferometer configured to receive Raman wavelengths from the sample.

2. The device of claim 1, wherein the excitation source is a light emitting diode, laser source, coherent source, incoherent source, or combinations thereof.

3. The device of claim 2, further comprising a focus element configured to disperse the wavelengths on the sample.

4. The device of claim 1, further comprising one or more band pass filters, the one or more band pass filters being configured to remove light outside of the Raman wavelengths.

5. The device of claim 1, further comprising one or more blocking filters.

6. The device of claim 1, further comprising a charge coupled device or intensified charge coupled device configured to collect Raman wavelengths.

7. The device of claim 1, wherein the spatial heterodyne filter further comprises a diffraction grating or dispersive prism, the grating or prism configured to adjust the wavelengths.

8. The device of claim 7, wherein the grating angle is configured to be adjusted.

9. The device of claim 8, wherein the spatial heterodyne interferometer comprise one or more simple wedge prisms to further increase the acceptance angle.

10. A method for spectroscopy comprising:
illuminating a sample with wavelengths from an excitation source; and
utilizing a spatial heterodyne interferometer to receive Raman wavelengths from the sample.

11. The method of claim 10, further comprising one or more band pass filters, the one or more band pass filters removing light outside the Raman wavelengths.

12. The method of claim 10, further comprising one or more detectors, the one or more detectors detecting ambient light, vibrational instabilities, or combinations thereof.

13. The method of claim 10, wherein the spatial heterodyne filter further comprises a diffraction grating or prism, the grating or prism being moved to adjust the wavelengths.

14. The method of claim 10, further comprising utilizing the spatial heterodyne interferometer to perform time-resolved Raman spectroscopy.

15. The method of claim 10, wherein the excitation source is a pulsed laser.

16. The method of claim 10, wherein the excitation source is a modulated excitation source, and wherein the spatial heterodyne interferometer is gated.

17. The method of claim 10, wherein Stokes and anti-Stokes Raman wavelengths are measured simultaneously.

18. The method of claim 10, further comprising determining the sample temperature.

19. The method of claim 10, wherein the sample comprises biomarker, mineral, rock, ice, light sensitive material, or combinations thereof.

20. The method of claim 10, wherein the sample comprises a high explosive.

21. The method of claim 10, wherein the spatial heterodyne interferometer is configured as a microRaman device for point measurements or imaging to produce chemical maps.

22. The method of claim 10, wherein the spatial heterodyne interferometer is configured as an in-situ chemical sensor to obtain chemical information that is capable of being utilized for chemical reaction control or additive manufacturing.

23. The method of claim 10, wherein the spatial heterodyne interferometer is utilized to perform analysis on multiple spectroscopies.
